(19) United States
(12) Patent Application Publication
(10) Pub. No.: US 2013/0154929 A1
(43) Pub. Date: Jun. 20, 2013

(54) MULTIPLE-LAYER POINTING POSITION DETERMINATION ON A MEDICAL DISPLAY

(71) Applicant: Sebastian Stopp, Munich (DE)

(72) Inventor: Sebastian Stopp, Munich (DE)

(21) Appl. No.: 13/818,474

(22) PCT Filed: Aug. 27, 2010
(86) PCT No.: PCT/EP2010/062557

§ 371 Date: Feb. 22, 2013

(51) Int. Cl. G06F 3/0488

(52) U.S. Cl. CPC G06F 3/0488
USPC 345/157

(57) ABSTRACT

The invention relates to a medical display (10) comprising a position determination system for ascertaining the position of at least one pointer (1) which is pointing onto the display surface (7) of the display (10), wherein the position determination system uses mufti-layered pointing position determination, wherein position-determining layers (A, B) each ascertain a two-dimensional pointing intersection (5, 6), and wherein said layers (A, B) are spaced from each other and arranged one above the other in relation to the display surface. The invention also relates to a method of making inputs on a medical display (10) by ascertaining the position of at least one pointer (1) which is pointing onto the display surface (7) of the display (10), wherein the pointing position (8) on the display and/or the orientation of the pointer (1) are determined using muiti-layered pointing position determination, wherein position-determining layers (A, B) each ascertain a two-dimensional pointing intersection (5, 6), and wherein said layers (A, B) are arranged one above the other in relation to the display surface,

The present invention relates to multiple-layer pointing position determination on a medical display. In particular, it relates to a medical display comprising a position determination system for ascertaining the position of at least one pointer which is pointing onto a display surface of the display.

Displays which can be used as an input means for a computer or data processor associated with the display are known and are in particular embodied as so-called touch-screens. There are touch-screens available which use a single planar touch sensor which can register single or multiple touch events. In order to discriminate against false touches, U.S. Pat. No. 6,492,979 B1 for example proposes using two different touch sensors on one touch-screen, said sensors being arranged on and coupled to the touch-screen in a single plane on the surface of the touch-screen.

It transpires that the number and variety of inputs which can be made on such touch-screens is limited. Special gestures and movements accompanying single or multiple touch events have thus been proposed in order to provide a great number of different input commands, but it is difficult to keep these movements and gestures memorable, simple and intuitive.

It is the object of the present invention to provide a form of pointing position determination which offers a large variety of intuitive input options. In accordance with one aspect of the present invention, this object is achieved by a medical display comprising a position determination system in accordance with claim 1. Another aspect of the present invention relates to a method of making inputs on a medical display by means of ascertaining the position of at least one pointer which is pointing onto the display surface of the display in accordance with claim 11. The sub-claims define advantageous embodiments of the invention.

The medical display of the present invention comprises position-determining layers which each ascertain a two-dimensional pointing intersection and which are spaced from each other and arranged one above the other in relation to the display surface. In other words, one of the layers is arranged at a distance above the other layer which is located closer to or directly on the display surface. The two layers could also be said to be arranged in two planes, wherein at least one plane is further from the display surface and exhibits a certain distance from the other plane.

Within the context of the present patent specification, the term “layer” as used in connection with the position-determining layers mentioned above defines a planar arrangement which can exhibit a certain width in the direction perpendicular to the display surface. The description of the layers as being arranged “one above the other” does not mean that the two layers cannot contact each other, but rather merely defines that the effective planes in which a pointing intersection is recognised are spaced from each other. In particular, this definition is not limiting to the effect that the structural elements which create or accommodate the layers or the devices which create the layers cannot contact each other or be arranged one above the other in a coupled manner.

Using the method of pointing position determination in accordance with the present invention, touch events can be recognised as inputs for which three-dimensional (co-ordinate) information is generated. This is particularly useful for controlling content which is displayed three-dimensionally, such as for example 3D medical data sets. It is then no longer necessary to learn an array of special movements and gestures or to use mouse devices or joysticks which can be operated three-dimensionally, because using the medical display in accordance with the present invention will enable the associated computer system to recognise the direction in which the pointer is pointing onto the display. This supplementary directional information adds to and completes the user's range of possible inputs in a highly intuitive fashion, as will be explained below by means of more detailed examples.

Within the context of the present patent specification, the term “pointer” defines any element which can be used to point to a certain spot on a display surface. Such pointers can of course comprise any elongated structure including, for example, pointers which are specifically adapted to be used with medical displays or light boxes, in particular digital light boxes. Using the present invention with such digital light boxes, as for example described in EP 2 017 756 A1, is particularly advantageous. The above-referenced “pointer” can of course also simply be a user's finger pointing to an element on the display.

The present invention thus enables the orientation of the pointer (finger, pen or stylet) to be acquired, in addition to the two-dimensional co-ordinates of the pointing event. Actual three-dimensional control is thus possible on a pointer-sensitive display.

In accordance with the present invention, the position-determining layers can be arranged in close proximity to the display surface, in particular such that they do not exceed the confines of the medical display or its outer frame. This serves to create a compact and integral system which is largely invulnerable to disturbances.

In one embodiment, the first layer or the position-determining layer which is closest to the display surface is arranged above and at a distance from the display surface. Such systems could be defined as “non-touch” screens because the layer closest to the display surface is directly above said surface and recognises a pointing intersection immediately above the plane of the display surface. Such a structure gives the user the impression of using an actual touch-sensitive screen, but without having to provide the display surface with any of the tactile elements needed for conventional touch-screens. Thus, any shortcomings in display quality inherent in using an actual touch-screen as the screen can be avoided, thus enabling the display quality to be enhanced substantially.

In another embodiment, the first position-determining layer (as viewed from the display surface) is arranged on the display surface or incorporated into the display surface, in particular in the manner of a touch-sensitive screen, i.e. in the present invention, an actual touch-screen can of course also be used as the first layer. This structure can be advantageous if the medical display as a whole is to be kept as thin and/or flat as possible. Any known technology can be used as the touch-screen technology, such as for example resistive or capacitive touch-screen technologies. It should be noted that in each general or detailed embodiment of the present invention, the position-determining layers can have various configurations, such as for example that of resistive, capacitive, optical, projective or acoustic touch-screens or position-determining devices on displays.

In accordance with one variant of the present invention, the position determination system comprises two position-determining layers, which is generally sufficient to provide pointer orientation information while still keeping the medical display as a whole sufficiently flat.

The position-determining layers which are arranged above and at a distance from the display surface advantageously include an optical position-determining layer or one such optical layer for each of the position-determining layers. Said optical position-determining layers can comprise a monitoring camera system which monitors a limited-width layer above the display surface, wherein it can be advantageous in such systems to arrange the position-determining layers in one or more frames which are located on and extend from the outer periphery of the display surface. In the latter case, the frames can comprise a recognisable, in particular reflective, surface in the area which is visible to the camera or camera system, in order to be able to easily and accurately determine disturbances in the camera picture caused by pointing intersections.

The optical position-determining layer of the present invention is not limited to this embodiment as a camera system, but rather can equally comprise an optical position determination grid, a laser grid or any planar intersection-detecting system which operates for example in the manner of a light barrier system.

The method of making inputs on a medical display in accordance with the present invention involves determining the pointing position on the display and/or the orientation of the pointer using multi-layered pointing position determination, wherein position-determining layers each ascertain a two-dimensional pointing intersection, and wherein said layers are arranged one above the other in relation to the display surface. The method thus defined also of course exhibits all the advantages described above with respect to the variety of possible embodiments of medical displays in accordance with the invention.

In the method according to the present invention, the pointing position and the orientation of the pointer can be analysed with computer assistance, in particular within a data processor included in or associated with the medical display, wherein the pointer orientation data are in particular used to create special orientation-dependent inputs, commands or display features.

The method as defined above can use the data concerning the orientation of the pointer to perform one or more of the following actions:
separating input events by different users or user's hands by analysing the pointing direction;
rotating displayed objects, in particular three-dimensionally displayed objects, by changing the pointer orientation while pointing to the objects, in particular while pointing to a special rotation spot or centre of rotation on or in the vicinity of the object;
influencing the viewing direction onto or into a displayed object while the point of view changes in depth with respect to the object, i.e. for example as it enters or leaves the object in the manner of an endoscope;
activating control icons in different ways in order to issue different inputs or commands, by activating the icons from different directions;
controlling a three-dimensionally displayed graphic user interface from different directions;
in planning procedures for medical operations or activities, defining certain areas, planes, incisions or trajectories in desired orientations by directing the pointer in a certain, respectively orientated manner.

In other aspects, the invention relates to a program which, when it is running on a computer or is loaded onto a computer, causes the computer to perform a method as described above in various embodiments. The invention also relates to a computer program storage medium which comprises such a computer program.

The invention will now be described in more detail by referring to a particular embodiment and to the attached drawings. It should be noted that each of the features of the present invention as referred to here can be implemented separately or in any expedient combination. In the drawings:

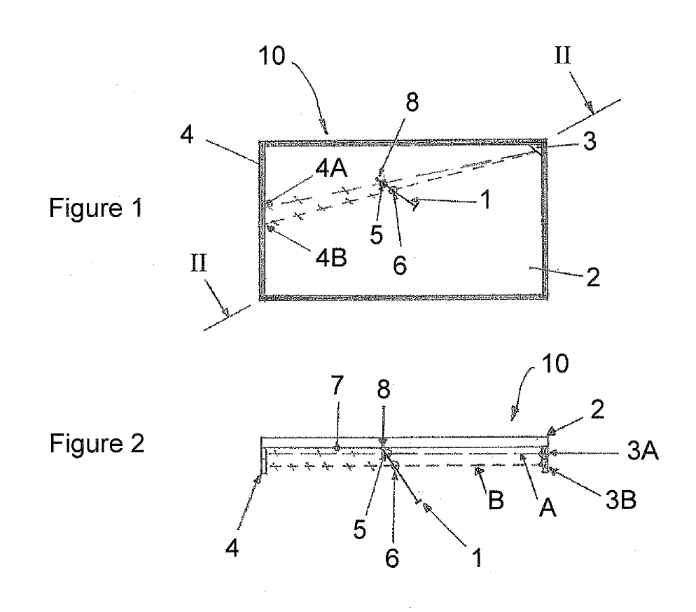

FIG. 1 is a front view of a medical display in accordance with the present invention; and

FIG. 2 is a sectional view along the plane II-II indicated in FIG. 1.

In the figures, an example of a medical display designed in accordance with the present invention is indicated by the reference numeral 10. It comprises a flat display body 2 comprising a display surface 7 on its front side. The display surface 7 shows for example medical images such as two-dimensional and/or three-dimensional models of body parts which can originate from data based on patient scans such as CT scans, MR scans, etc. Icons or other control display elements which can be used as input means can also be shown on the display surface 7.

In accordance with the present invention, the medical display 10 is intended to be used on the one hand as a display means and on the other hand as an input means for example for changing the display characteristics of displayed features or for adding additional features or for planning operations, etc. To this end, the medical display 10 is equipped with a position determination system for ascertaining the position of a pointer used to create such inputs, wherein the pointer is indicated in the figures by the reference numeral 1. The pointer 1 is an elongated pen-like device which does not have to exhibit any special features in order to fulfil its pointing function. As such, it could easily be replaced by a person's finger(s).

In order to determine the position and orientation of the pointer 1, a frame 4 is mounted to the periphery of the display body 2 and extends perpendicularly from the surface of the display body 2. As viewed in the perpendicular direction just mentioned, the frame 4 comprising two parts, each part comprising a camera 3 in the upper right-hand corner of the display, as shown in FIG. 1, said camera 3 exhibiting a field of view which extends in a plane parallel to and at a certain distance from the display surface 7. The camera 3A is located in the first portion of the frame 4, closer to the display surface 7, while the camera 3B is located in the other portion of the frame 4 at a defined distance and further away from the display surface 7. The effective viewing planes (referred to here in general as “position-determining layer”) of the cameras 3A and 3B are indicated in FIG. 2 by the capital letters A and B.

The inside of the remaining portions of the frame 4 is coated with a retro-reflective covering, such that the two cameras 3A and 3B “see” a continuous image from the inside of the frame, with no disturbances or interruption of the viewing planes.

If a user takes a pointer 1 and points it at a particular spot on the display surface 7, i.e. for example the spot indicated in the figures by the reference numeral 8, the pointer 1 will intersect the viewing planes A and B of the two cameras. In other words, the pointer 1 intersects two position-determining layers which are at different distances from the display surface 7.

Inserting the pointer 1 into the position and orientation determination system designed in this way also means that the locations 4A and 4B on the inside of the frame (FIG. 1) are no longer visible to the cameras 3A and 3B, i.e. the cameras 3A and 3B will register a certain disturbance at said certain spots of the viewing plane instead of the previously continuous image of the reflective inner surface of the frame. In the figures, the lack of visibility of the points 4A and 4B has been indicated by crosshatching the dotted lines of the viewing planes A and B in FIG. 2 and the lines of sight in FIG. 1 beyond the intersection points 5 and 6. Using this general principle, as applicable in combination with one or more cameras in each layer on the same frame edge or one of the other frame edges, the two-dimensional co-ordinates of the intersection points 5 and 6 can be calculated by processing the directional data obtained from the camera system. In this respect, the embodiment of FIGS. 1 and 2 is intended to demonstrate this principle, but can—as mentioned above—be altered in order to obtain better positional information by adding camera systems around the frame or perpendicular to the display surface 7 (for example, by adding more position-determining layers or by altering the frame's structure or covering).

A data processing unit which is incorporated in the medical display 10 itself or is associated with or connected to the medical display 10 (and which may already have been used to calculate the two-dimensional co-ordinates of the points 5 and 6, but is not shown in the drawings) can then be provided with these two planar co-ordinates, from which—together with the known distances between the planes A and B and the display surface 7)—the data processing unit can calculate not only the exact location which the pointer 1 is pointing to, i.e. the point 8, but also the spatial or three-dimensional direction from which it is pointing. The orientation of the pointer 1 is therefore known and can be used for various purposes, as explained below.

One example of such a purpose would be to separate multiple touch or pointing events performed by different hands and/or users. Existing multi-operational displays (multi-touch-screens) allow multiple pointing events at the same time, but it is not always easy to separate the events and correctly assign them to one of various hands and/or users. However, if—as in the present invention—the orientation of the pointer is known in addition to the spot being pointed at, it is entirely possible to deduce whether the pointing event originated from the right or the left, i.e. from a user or user's hand to the right or left of the centre of the display.

Another example features intuitive three-dimensional model rotation which can be achieved by using two-dimensional position data and the ascertained orientation of the pointer. The pointer can for example be used to touch a centre of rotation on the three-dimensional model (for example, a model of a part of a patient's body) on the display. The three-dimensional model would then be rotated in accordance with the orientation of the pointer. While the system is in such a “rotation mode”, the centre of rotation could also be changed by moving the pointer tip to another point of the three-dimensional model.

Virtual endoscopy may be regarded as a subset of such three-dimensional model rotation. In such an embodiment, the pointer tip is used to determine a centre spot, and the orientation of the pointer can be taken as the direction in which to “fly into” or enter the model as an endoscope would. One application for this feature would be in navigated Ear, Nose and Throat surgeries in which intuitive control of a three-dimensional model view is needed but has always represented a challenge.

The present invention can also be used to create and utilise three-dimensional icons as control means which are displayed on the display surface 7, instead of two-dimensional icons. The direction of a “button press” event can then for example be used to issue different commands depending on the direction, such as for example “activate” or “open a sub-menu”.

In three-dimensional display GUI (Graphic User Interface) control, three-dimensional displays can be used not only for three-dimensional films but also for three-dimensional GUI content. A merely two-dimensional form of control is not sufficient to enable the user to have full and intuitive control over a three-dimensional GUI comprising a three-dimensional display. Using the known orientation and position of the pointer in accordance with the present invention, however, the user can exercise three-dimensional control over a three-dimensional display.

The present invention can also be used to plan surgical operations, without the method of the present invention itself being or involving a surgical or therapeutic step. The method in accordance with the invention is non-therapeutic and non-surgical in each of its embodiments as described herein. In any planning applications, the additional orientation information for the pointer can be used to more flexibly define areas or incisions to be drawn or indicated in the display content (such as for example three-dimensional models of a part of a patient's body). It would then for example be possible to view the three-dimensional model on the display from the front while placing or planning an angular incision by holding the pointer in a certain orientation. In order to support the user in this activity, the orientation could be displayed on the display surface or for example any anatomical plane with respect to the display surface in angular degrees.

As mentioned above, the present invention can advantageously be used with digital light boxes, but can in principle be used with any medical display which exhibits touch-screen properties or pointer position determination properties.

1. A medical display comprising a position determination system for ascertaining the position of at least one pointer which is pointing onto the display surface of the display, characterised in that the position determination system uses multi-layered pointing position determination, wherein position-determining layers each ascertain a two-dimensional pointing intersection and wherein said layers are spaced from each other and arranged one above the other in relation to the display surface.

2. The medical display according to claim 1, characterised in that the position-determining layers are arranged in close proximity to the display surface, in particular such that they do not exceed the confines of the medical display or its outer frame.

3. The medical display according to claim 1, characterised in that the first layer or the position-determining layer which is closest to the display surface is arranged above and at a distance from the display surface.

4. The medical display according to claim 1, characterised in that the first position-determining layer is arranged on the display surface or incorporated into the display surface, in particular in the manner of a touch-sensitive screen.

5. The medical display according to claim 1, characterised in that the position determination system comprises two position-determining layers.

6. The medical display according to claim 1, characterised in that the position-determining layers which are arranged above and at a distance from the display surface include an optical position-determining layer.

7. The medical display according to claim 6, characterised in that the optical position-determining layer comprises a monitoring camera system which monitors a limited-width layer above the display surface.

8. The medical display according to claim 7, characterised in that the optical position-determining layer which is arranged above and at a distance from the display surface is located in one or more frames which are arranged on and extend from the outer periphery of the display surface.

9. The medical display according to claim 8, characterised in that the frames comprise a recognisable, in particular reflective, surface in the area which is visible to the camera or camera system.

10. The medical display according to claim 6, characterised in that the optical position-determining layer comprises an optical position determination grid, in particular a laser grid.

11. A method of making inputs on a medical display by ascertaining the position of at least one pointer which is pointing onto the display surface of the display, characterised in that the pointing position on the display and/or the orientation of the pointer are determined using multi-layered pointing position determination, wherein position-determining layers each ascertain a two-dimensional pointing intersection, and wherein said layers are arranged one above the other in relation to the display surface.

12. The method of claim 11, wherein the data concerning the pointing position and the orientation of the pointer are analysed with computer assistance, in particular within a data processor included in or associated with the medical display, and wherein the pointer orientation data are in particular used to create special orientation-dependent inputs, commands or display features.

13. The method of claim 12, wherein the data concerning the orientation of the pointer are used to perform one or more of the following actions:
separating input events by different users or user's hands by analysing the pointing direction;
rotating displayed objects, in particular three-dimensionally displayed objects, by changing the pointer orientation while pointing to the objects, in particular while pointing to a special rotation spot or centre of rotation on or in the vicinity of the object;
influencing the viewing direction onto or into a displayed object while the point of view changes in depth with respect to the object, i.e. for example as it enters or leaves the object in the manner of an endoscope;
activating control icons in different ways in order to issue different inputs or commands, by activating the icons from different directions;
controlling a three-dimensionally displayed graphic user interface from different directions;
in planning procedures for medical operations or activities, defining certain areas, planes, incisions or trajectories in desired orientations by directing the pointer in a certain, respectively orientated manner.

14. A program which, when it is running on a computer or is loaded onto a computer, causes the computer to perform a method in accordance with claim 11.

15. A computer program storage medium which comprises a computer program according to claim 14.
